(19) United States
(12) Patent Application Publication
(10) Pub. No.: US 2026/0153789 A1
(43) Pub. Date: Jun. 4, 2026

(54) SURVEILLANCE CAMERA INCLUDING COMMON GIMBAL ASSEMBLY

(71) Applicant: IDIS CO., LTD., Daejeon (KR)

(72) Inventor: Jin Woo KIM, Seoul (KR)

(73) Assignee: IDIS CO., LTD., Daejeon (KR)

(21) Appl. No.: 19/284,565

(22) Filed: Jul. 29, 2025

(30) Foreign Application Priority Data
Dec. 3, 2024 (KR) 10-2024-0177143

(51) Int. Cl. G03B 17/08; G03B 17/56; H04N 23/66; H04N 23/68

(52) U.S. Cl. CPC G03B 17/08; G03B 17/561; H04N 23/66; H04N 23/68

(57) ABSTRACT

According to one aspect of the present invention, since a tilt motor is provided in a common gimbal assembly and the common gimbal assembly is rotationally driven about a tilt axis by rotational driving of a tilt motor, the common gimbal assembly can be compatibly applied to any type of surveillance camera.

### CROSS-REFERENCE TO RELATED APPLICATION(S)

This application claims priority from Korean Patent Application No. 10-2024-0177143, filed on Dec. 3, 2024 in the Korean Intellectual Property Office, the disclosure of which is incorporated herein by reference in its entirety.

### BACKGROUND

### 1. Field

The following description relates to a surveillance camera technology.

### 2. Description of Related Art

Surveillance cameras are widely distributed for crime prevention and monitoring of specific behaviors. Particularly, pan-tilt (PT) surveillance cameras can be fixed to walls, ceilings, or supports, and automatically or remotely controlled to capture images of wide areas. The PT surveillance cameras may have a pan and tilt function.

PT surveillance cameras are divided into dome-type surveillance cameras and bullet-type surveillance cameras according to installation environments and may be further divided into surveillance cameras of other types. However, since a type of a surveillance camera should be changed when an installation environment is changed, a user has a problem that a cost burden increases. Accordingly, it is necessary to minimize an installation cost burden of a user by commonly or compatibly using some components including a camera module and separately using the other components according to an installation environment.

Although a dome type pan-tilt-zoom (PTZ) surveillance camera is disclosed in Korean Patent Registration No. 10-1731599, this structure cannot be converted to a bullet-type surveillance camera which use components including a camera module without change.

### SUMMARY

The proposed invention is directed to providing a technology of a surveillance camera compatible with any of surveillance cameras with different types.

In accordance of one aspect of the proposed invention, since a tilt motor is provided in a common gimbal assembly and the common gimbal assembly is rotationally driven about a tilt axis by rotational driving of a tilt motor, the common gimbal assembly may be compatibly applied to any type of surveillance camera.

### BRIEF DESCRIPTION OF THE DRAWINGS

FIG. 1 is a view illustrating a dome-type surveillance camera including a common gimbal assembly according to one embodiment.

FIG. 2 is a view illustrating a bullet-type surveillance camera including a common gimbal assembly according to another embodiment.

FIG. 3 is a view illustrating an exterior of the common gimbal assembly according to one embodiment.

FIG. 4 is an exploded view illustrating the common gimbal assembly according to one embodiment.

FIG. 5 is an exploded view illustrating the dome-type surveillance camera including the common gimbal assembly according to one embodiment.

FIG. 6 is an exploded view illustrating a bullet-type surveillance camera including the common gimbal assembly according to one embodiment.

FIG. 7 is a cross-sectional view illustrating the bullet-type surveillance camera including the common gimbal assembly according to one embodiment.

### DETAILED DESCRIPTION

The above-described and additional aspects of the present invention will be implemented through embodiments described with reference to the accompanying drawings. It is understood that components in the embodiments may be variously combined in one embodiment as long as there are no contradictory statements therebetween. Terms used in the present specification and claims should be interpreted as having meanings and concepts which are consistent with the described content or the technological scope of the present invention based on the principle that the inventors have appropriately defined concepts of the terms in order to describe the present invention in the best way. Hereinafter, exemplary embodiments of the present invention will be described in detail with reference to the accompanying drawings.

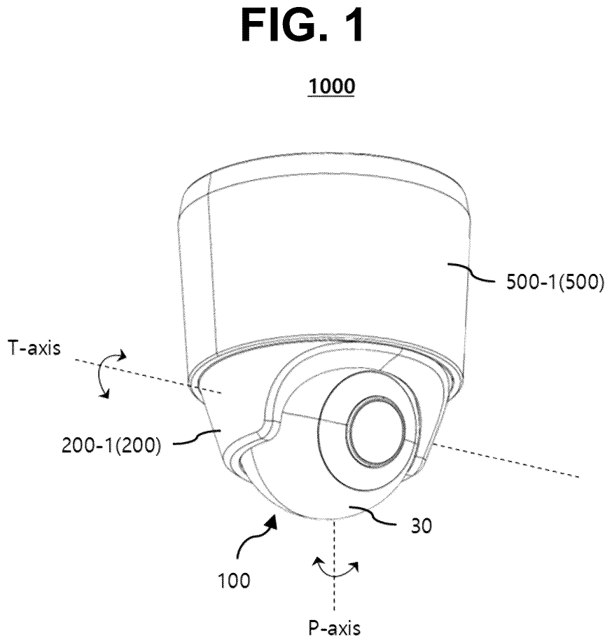

FIG. 1 is a view illustrating a dome-type surveillance camera including a common gimbal assembly according to one embodiment. As illustrated in the drawing, a surveillance camera 1000 according to one embodiment may include a gimbal assembly 100, a gimbal cover 30, a tilt cover 200, and a protection cover 500. The gimbal assembly 100 may rotate about a tilt axis T-axis and also rotate about a pan axis P-axis.

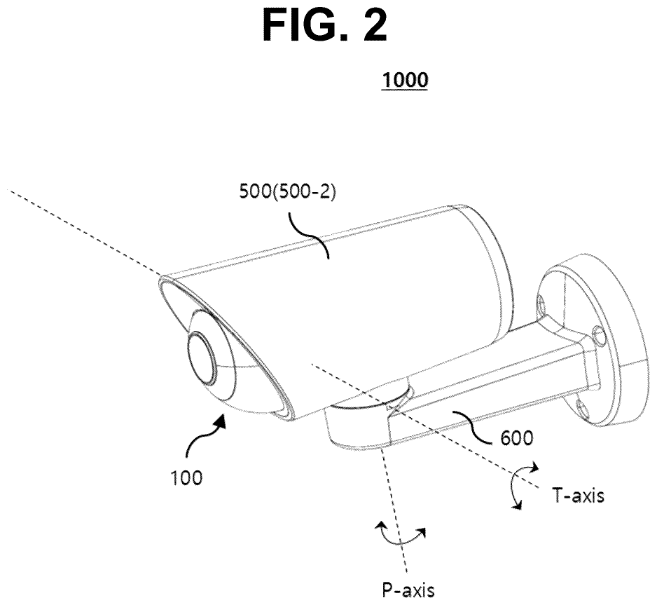

FIG. 2 is a view illustrating a bullet-type surveillance camera including a common gimbal assembly according to another embodiment. As illustrated in the drawing, a surveillance camera 1000 according to one embodiment may include a gimbal assembly 100, a gimbal cover 30, a tilt cover 200, a protection cover 500, and a holder 600. The gimbal assembly 100 may rotate about a tilt axis T-axis and also rotate about a pan axis P-axis.

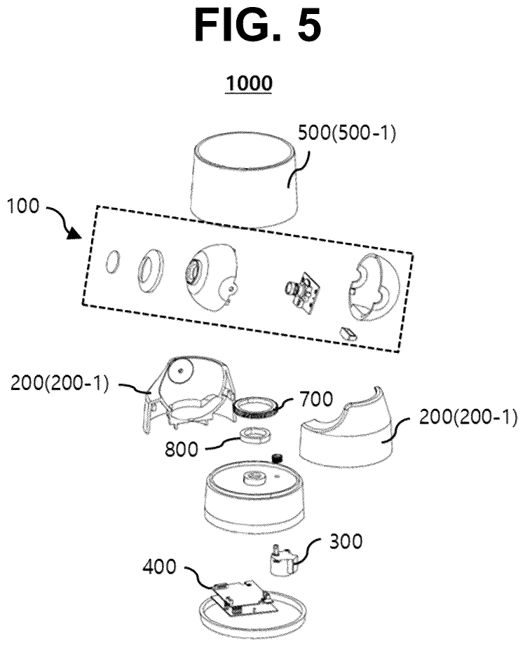

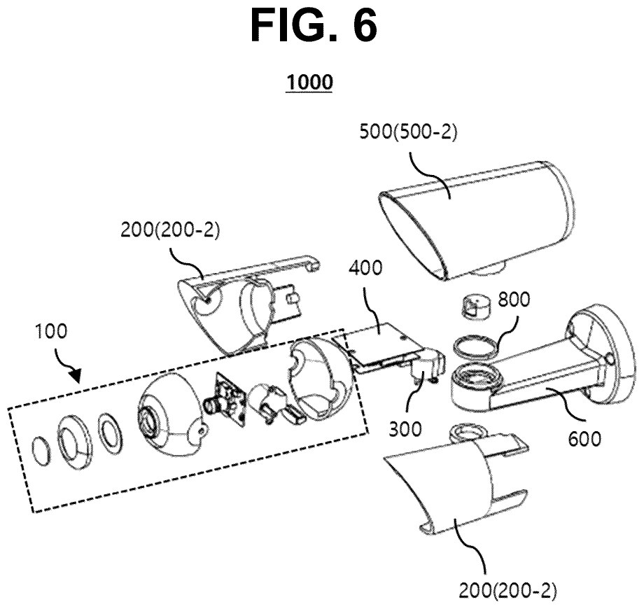

In FIGS. 1 and 2, the tilt cover 200 may be classified as a dome type tilt cover 200-1 or a bullet type tilt cover 200-2, which have different shapes (see FIGS. 5 and 6), or the protection cover 500 may be classified as a dome type protection cover 500-1 or a bullet type protection cover 500-2, which have different shapes.

There may be additional types of surveillance camera 1000 according to a shape of an exterior.

According to one aspect of the present invention, as a tilt motor is provided in the common gimbal assembly, and the common gimbal assembly is rotationally driven about the tilt axis by rotational driving of the tilt motor, the common gimbal assembly may be compatibly applied to any type of surveillance camera.

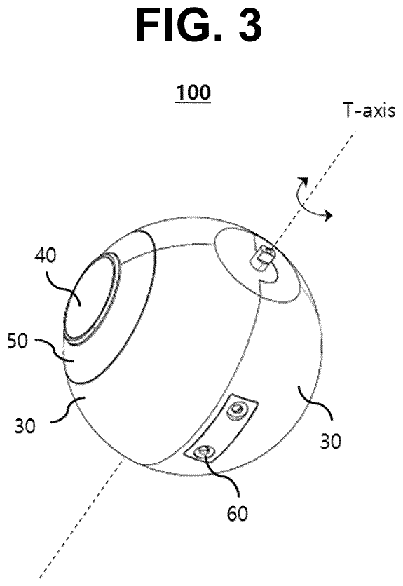

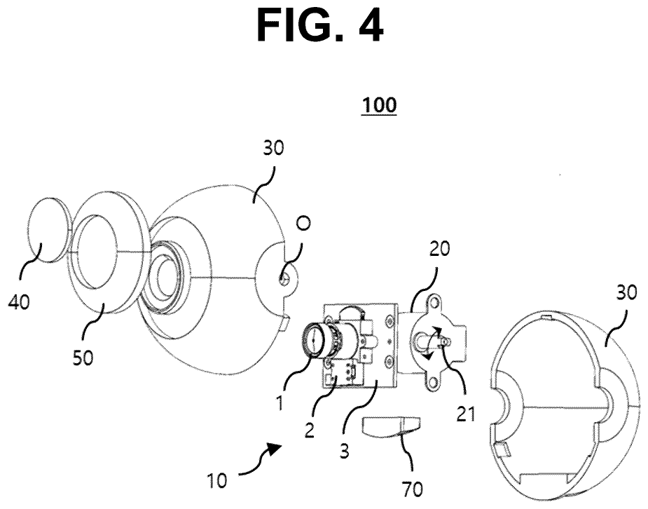

FIG. 3 is a view illustrating an exterior of the common gimbal assembly according to one embodiment. FIG. 4 is an exploded view illustrating the common gimbal assembly according to one embodiment. As illustrated in FIGS. 3 and 4, the surveillance camera 1000 according to one embodiment includes the common gimbal assembly 100. The common gimbal assembly 100 may rotate about the tilt axis T-axis. The common gimbal assembly 100 includes a camera module 10, a tilt motor 20, and the gimbal cover 30. The camera module 10 includes a lens assembly 1, an image sensor 2, and a camera substrate 3 on which the lens assembly 1 and the image sensor 2 are mounted. The camera substrate 3 may include a printed circuit board (PCB).

A shaft 21, which is rotationally driven about the tilt axis T-axis, is provided on one side surface of the tilt motor 20. The tilt motor 20 may include a step motor or a servo motor but is not limited thereto. The gimbal cover 30 may fixedly surround the camera module 10 and the tilt motor 20 and have a predetermined shape, and at least of a portion of the gimbal cover 30 may be formed in a curved shape. The predetermined shape may be a shape which may be commonly applied to various types. The common gimbal assembly 100 may further include a window 40 which protects the camera module 10 and through which a lens receives reflective light and a pass filter 50 which blocks light of a specific wavelength and further include a connecting port 60 for electrically connecting the camera module 10 to an external component. A portion of the connecting port 60 may be sealed for waterproofing. The common gimbal assembly 100 may further include a secure digital (SD) card cab 70 in the gimbal cover 30.

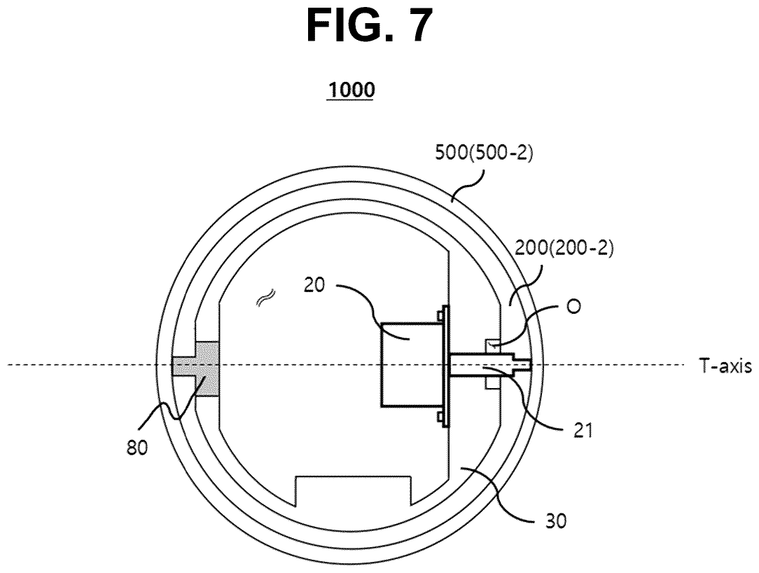

According to one embodiment, an opening O may be formed in one side surface of the gimbal cover 30, at least a portion of the shaft 21 passes through the opening O, and one end of the shaft may be formed to protrude outward from the gimbal cover 30. The opening O and the shaft 21 may be disposed to overlap the tilt axis T-axis (see FIG. 7).

As the tilt motor 20 is provided in the common gimbal assembly 100, and the common gimbal assembly 100 is rotationally driven about the tilt axis T-axis by rotational driving of the tilt motor 20, the common gimbal assembly 100 is advantageous for being compatibly applied to any type of surveillance camera.

According to one embodiment, the surveillance camera 1000 may further include the tilt cover 200. The tilt cover 200 may surround at least a portion of the common gimbal assembly 100, and at least a portion of the tilt cover 200 may be formed in a curved shape. A portion of the tilt cover 200 may have a curved shape corresponding to the gimbal cover 30. One end of the shaft 21 may be fixedly coupled to the tilt cover 200. Accordingly, the common gimbal assembly 100 may perform a tilting operation according to rotation of the shaft 21.

According to one embodiment, the tilt cover 200 may be classified as the dome type tilt cover 200-1 or the bullet type tilt cover 200-2, which have the different shapes. Each of the dome type tilt cover 200-1 and the bullet type tilt cover 200-2 may be separated and assembled in a left-right direction. The dome type tilt cover 200-1 may have a vertically open shape, and the bullet type tilt cover 200-2 may have a shape which is open in a front-rear direction.

The surveillance camera 1000 according to one embodiment may further include a pan motor 300 and a control module 400. The pan motor 300 may be provided outside the common gimbal assembly 100 and rotate the common gimbal assembly about the pan axis P-axis. The pan motor 300 may include a step motor or a servo motor but is not limited thereto. The control module 400 may be provided outside the common gimbal assembly 100 and control (rotational) driving of the tilt motor 20 and the pan motor 300. The control module 400 may have a function of adjusting magnitudes and supply timings of power supplied to the image sensor 2, the tilt motor 20, and the pan motor 300. A panning operation of the common gimbal assembly 100 may be performed by the pan motor 300 and the control module 400. The control module 400 may include a PCB.

According to one embodiment, the surveillance camera 1000 may further include the protection cover 500. The protection cover 500 may surround at least a portion of each of the tilt cover 200, the pan motor 300, and the control module 400, and at least a portion of the protection cover 500 may be formed in a curved shape. At least a portion of the protection cover 500 may have a curved shape corresponding to the tilt cover 200.

According to one embodiment, the protection cover 500 may be classified as the dome type protection cover 500-1 or the bullet type protection cover 500-2, which have different shapes (see FIGS. 1 and 2). The surveillance camera 1000 may further include a gear 700 and a bearing 800 which are disposed outside the common gimbal assembly 100 and inside the protection cover 500 and exclusively applied to a corresponding type (see FIGS. 5 and 6).

FIG. 7 is a cross-sectional view illustrating the bullet-type surveillance camera including the common gimbal assembly according to one embodiment. For convenience, only the tilt motor 20 disposed in the gimbal cover 30 is illustrated in FIG. 7. As illustrated in the drawing, the surveillance camera 1000 may include the tilt motor 20 including the shaft 21 which is rotationally driven about the tilt axis T-axis and is disposed on one side surface of the tilt motor 20 and the gimbal cover 30 which fixedly surrounds the tilt motor and has the predetermined shape of which at least a portion is formed in the curved shape. In addition, the surveillance camera 1000 may further include the tilt cover 200 which surrounds at least a portion of the common gimbal assembly 100 and of which at least a portion is formed in the curved shape and the protection cover 500 which surrounds at least a portion of the tilt cover 200 and of which at least a portion is formed in the curved shape. The tilt motor 20 may be fixedly attached to an inner surface of the gimbal cover 30, the shaft 21 may be inserted into the opening O, and one end of the shaft 21 may be fixedly attached to the tilt cover 200.

The opening O may be formed in one side surface of the gimbal cover 30, at least of a portion of the shaft 21 may passes through the opening, and one end of the shaft 21 may be formed to protrude outward from the gimbal cover 30. The surveillance camera 1000 may further include a pivot member 80 at a location facing the shaft 21. The pivot member 80 may be inserted into the gimbal cover 30 and the tilt cover 200 and provide a pivot function such that the common gimbal assembly 100 may be tilted while supported by the tilt cover 200. In FIG. 7, the bullet type tilt cover 200-2 is illustrated as the tilt cover 200, the bullet type protection cover 500-2 is illustrated as the protection cover 500, and the dome type tilt cover 200-1 and the bullet type protection cover 500-1 may be applied in the same way.

According to a proposed invention, costs of installing a surveillance camera can be reduced, and resource waste and environmental pollution can be prevented.

Effects of the present invention are not limited to the above-described effects, and other effects which are not described above will be clearly understood by those skilled in the art from the present specification and accompanying drawings.

Hereinabove, although the present invention has been described through embodiments described with reference to the accompanying drawings, the present invention is not limited thereto and should be construed as encompassing various modifications which may be clearly derived therefrom by those skilled the art. The claims are intended to encompass the various modifications.

While all the components constituting the embodiments of the invention have been descried to be combined into one component or operated in a combined manner, the invention is not necessarily limited thereto. That is, within the scope of the invention, all the components may also be selectively combined into at least one component and operated as one component.

What is claimed is:

1. A surveillance camera comprising a common gimbal assembly,
wherein the common gimbal assembly includes:
a camera module including a lens assembly, an image sensor, and a camera substrate on which the lens assembly and the image sensor are mounted;
a tilt motor of which one side surface is provided with a shaft rotationally driven about a tilt axis; and
a gimbal cover which surrounds the camera module and the tilt motor in a fixed state and has a predetermined shape of which at least a portion is formed in a curved shape, wherein
an opening is formed in one side surface of the gimbal cover,
at least a portion of the shaft passes through the opening, and
one end of the shaft is formed to protrude outward from the gimbal cover.

2. The surveillance camera of claim 1, further comprising a tilt cover which surrounds at least a portion of the common gimbal assembly and of which at least a portion is formed in a curved shape,
wherein the one end of the shaft is fixedly coupled to the tilt cover, and
the tilt cover is classified as a dome type tilt cover or a bullet type tilt cover, which have different shapes.

3. The surveillance camera of claim 2, further comprising:
a pan motor which is provided outside the common gimbal assembly and rotates the common gimbal assembly about a pan axis; and
a control module which is provided outside the common gimbal assembly and controls driving of the tilt motor and the pan motor.

4. The surveillance camera of claim 3, further comprising a protection cover which surrounds at least a portion of each of the tilt cover, the pan motor, and the control module and of which at least a portion is formed in a curved shape,
wherein the protection cover is classified as a dome type protection cover or a bullet type protection cover, which have different shapes.
